(19) United States
(12) Patent Application Publication
(10) Pub. No.: US 2019/0354312 A1
(43) Pub. Date: Nov. 21, 2019

(54) MEMORY SYSTEM WITH A VARIABLE SAMPLING RATE MECHANISM

(71) Applicant: Micron Technology, Inc., Boise, ID (US)

(72) Inventors: Francis Chew, Boulder, CO (US); Gerald L. Cadloni, Longmont, CO (US); Bruce A. Liikanen, Berthoud, CO (US); Michael Sheperek, Longmont, CO (US); Larry J. Koudele, Erie, CO (US)

(21) Appl. No.: 15/981,790

(22) Filed: May 16, 2018

(51) Int. Cl. G06F 3/06

(52) U.S. Cl. CPC G06F 3/0659; G06F 3/0679; G06F 3/0604

(57) ABSTRACT

A memory device includes a memory device comprising a plurality of memory cells; and a processing device coupled to the memory device, the processing device configured to: determine at least one real-time measure including at least one environmental parameter or at least one operational parameter, or a combination thereof, wherein: the environmental parameter corresponds to one or more physical conditions concerning the system, the operational parameter represents one or more operations performed by the system; and generate an adjusted sampling rate based on the real-time measure, wherein the adjusted sampling rate replaces a previous sampling rate used to control a timing associated with gathering information for a sampling process.

### RELATED APPLICATION(S)

This application contains subject matter related to a previously-filed U.S. patent application by Larry J. Koudele and Bruce A. Liikanen titled “MEMORY DEVICE WITH DYNAMIC PROCESSING LEVEL CALIBRATION.” The related application is assigned to Micron Technology, Inc., and is identified by application Ser. No. 15/605,858, which was filed on May 25, 2017. The subject matter thereof is incorporated herein by reference thereto.

This application contains subject matter related to a previously-filed U.S. patent application by Larry J. Koudele and Bruce A. Liikanen titled “MEMORY DEVICE WITH DYNAMIC TARGET CALIBRATION.” The related application is assigned to Micron Technology, Inc., and is identified by application Ser. No. 15/605,855, which was filed on May 25, 2017. The subject matter thereof is incorporated herein by reference thereto.

This application contains subject matter related to a previously-filed U.S. patent application by Bruce A. Liikanen and Larry J. Koudele titled “MEMORY DEVICE WITH DYNAMIC PROGRAMMING CALIBRATION.” The related application is assigned to Micron Technology, Inc., and is identified by application Ser. No. 15/605,853, which was filed on May 25, 2017. The subject matter thereof is incorporated herein by reference thereto.

### TECHNICAL FIELD

Embodiments of the disclosure relate generally to memory systems, and, in particular, to memory systems with a mechanism for varying a sampling rate.

### BACKGROUND

A memory system can be a storage system, such as a solid-state drive (SSD), and can include one or more memory components that store data. For example, a memory system can include memory devices such as non-volatile memory devices, volatile memory devices, or a combination of both. In general, a host system can utilize a memory system to store data at the memory devices of the memory system and to retrieve data stored at the memory system.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory system in accordance with some implementations of the present disclosure.

FIGS. 2A, 2B and 2C illustrate an example of a progression for a read level calibration in accordance with an embodiment of the present technology.

FIGS. 3A, 3B, and 3C illustrate an example of a progression for a program targeting calibration in accordance with an embodiment of the present technology.

FIGS. 4A and 4B illustrate an example of a progression for a program step calibration in accordance with an embodiment of the present technology.

FIG. 5 is a flow diagram of an example method for dynamically varying/adjusting one or more sampling rates in accordance with an embodiment of the present disclosure.

FIG. 6 is a block diagram of an example computer system in which implementations of the present disclosure can operate.

### DETAILED DESCRIPTION

Aspects of the present disclosure are directed to dynamically varying/adjusting one or more sampling rates (e.g., a timing or a frequency for gathering data/information) of a memory system. A memory system can be a storage system, such as a solid-state drive (SSD). In some embodiments, the memory system is a hybrid memory/storage system. In general, a host system can utilize a memory system that include media, such as one or more memory devices. The memory devices can include non-volatile memory devices, such as, for example, negative-and (NAND). The host system can provide write requests to store data at the memory devices of the memory system and can provide read requests to retrieve data stored at the memory system.

Traditional systems/devices often use a predetermined and fixed timing interval/cadence to perform many operations (e.g., data sampling for media management algorithms, such as for wear-leveling). As such, the timing interval/cadence does not change over the life of the systems/devices. For example, sampling rate or cadence for temperature and/or operating conditions, data error or storage cell defectivity rate (e.g., retention, endurance, physical defects, etc. associated with NANDs), performance metrics (e.g., read retry trigger rates, recovery depth, etc.), data refresh rate, folding rate, host activity or workload, changes therein, or a combination thereof can remain unchanged regardless of internal and/or external conditions. The inability to adapt to different operating conditions can result in less than optimal operational performance, such as increased errors, increased processing times, etc.

Aspects of the present disclosure address the above and other deficiencies by varying sampling rates utilized in various operations, such as background scans, calibration/adjustment operations (e.g., read level calibration, program target calibration, programming step calibration, etc.), other memory system management operations, etc. In some embodiments, the memory systems can vary the rate/frequency/cadence for a variety of different sampling processes, such as performance characteristics, error measures (e.g., bit error rates (BER), bit error counts, etc.), calibration-related reads/samplings, operating variables, operating temperatures, etc. Based on the adjusted/varying sampling rate, the memory systems can provide improved tracking of input parameters (e.g., operating temperature, error rates, etc.), greater accuracy of algorithms that rely on the sampled data, etc. Further, the increased accuracy of the algorithms can further provide improvements to overall system performance through lower trigger rates and better performance metrics.

In some embodiments, the memory devices can vary the sampling rate according to a number of different factors, such as NAND condition/defectiveness measure, data refresh, folding (e.g., consolidating and moving valid data portions for garbage collection), temperature, operating conditions, identity/type of ongoing or executed operation, changes in rates (e.g., error rates), changes in executed activity, trigger rate (e.g., rate of performing error recovery process), background scan execution or results, data refresh, etc. In some embodiments, the memory devices can use feedback/looped inputs, such as for varying the sampling rate of a measure when the measure satisfies or exceeds a threshold condition. For example, the memory devices can vary the temperature sampling rate when the reported temperature exceeds a predetermined threshold or vary the background scanning rate for BER when the BER exceeds a threshold level.

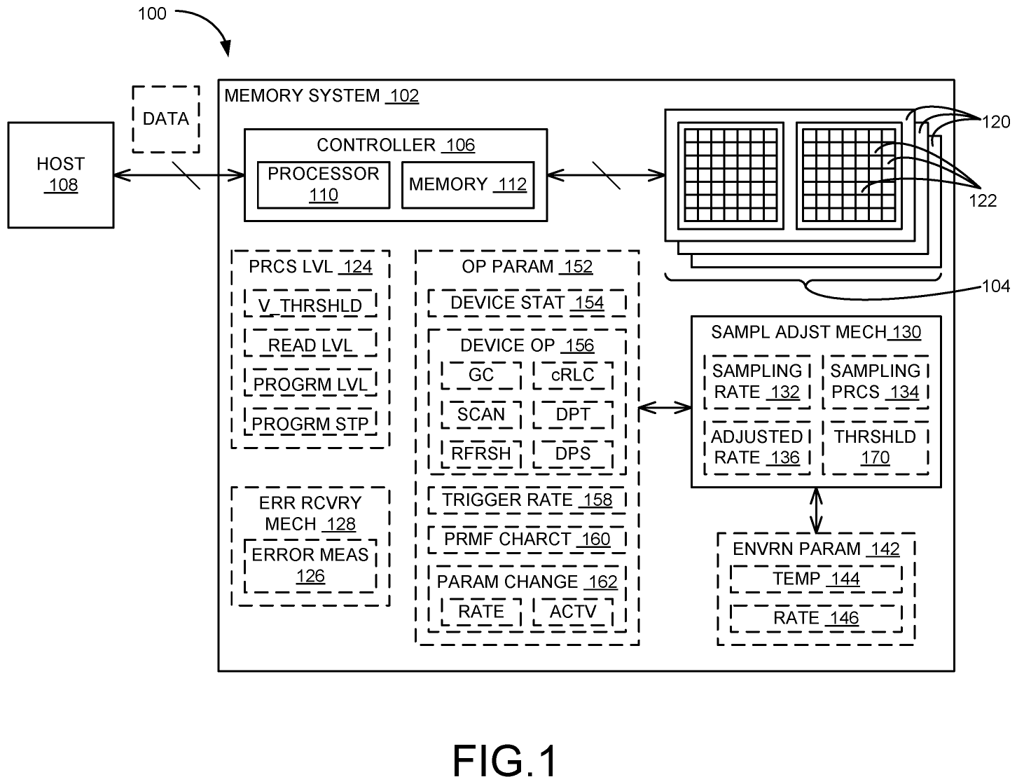

FIG. 1 is a block diagram of a computing environment 100 configured in accordance with an embodiment of the present technology. The computing environment 100 includes a memory system 102. As shown, the memory system 102 includes one or more memory devices 104 (e.g., NAND flash) and a controller 106. The memory system 102 can operably couple the memory devices 104 to a host device 108 (e.g., an upstream central processor (CPU)). The memory devices 104 can include circuitry configured to store data in the memory devices 104 and provide access to data in the memory devices 104. The memory devices 104 can be provided as semiconductor, integrated circuits and/or external removable devices in computers or other electronic devices. The memory devices 104 includes one or more memory regions, or memory units 120. The memory units 120 can be individual memory dies, memory planes in a single memory die, a stack of memory dies vertically connected with through-silicon vias (TSVs), or the like. In one embodiment, each of the memory units 120 can be formed from a semiconductor die and arranged with other memory unit dies in a single device package (not shown). In other embodiments, one or more of the memory units 120 can be co-located on a single die and/or distributed across multiple device packages. The memory system 102 and/or the individual memory units 120 can also include other circuit components (not shown), such as multiplexers, decoders, buffers, read/write drivers, address registers, data out/data in registers, etc., for accessing and/or programming (e.g., writing) the data and other functionality, such as for processing information and/or communicating with the controller 106.

Each of the memory units 120 includes an array of memory cells 122 that each store data. The memory cells 122 can include, for example, floating gate, charge trap, phase change, ferroelectric, magnetoresitive, and/or other suitable storage elements configured to store data persistently or semi-persistently. The memory cells 122 can be one-transistor memory cells that can be can be programmed to a target state to represent information. For instance, electric charge can be placed on, or removed from, the charge storage structure (e.g., the charge trap or the floating gate) of the memory cell 122 to program the cell to a particular data state. The stored charge on the charge storage structure of the memory cell 122 can indicate a threshold voltage (Vt) of the cell. For example, a single level cell (SLC) can be programmed to a targeted one of two different data states corresponding to different threshold voltages which can represent the binary units 1 or 0.

Some memory cells (e.g., flash memory cells) can be programmed to a targeted one of more than two data states. For example, a memory cell that can be programmed to any one of four states (e.g., represented by the binary 00, 01, 10, 11) can be used to store two bits of data, and may be referred to as a multilevel cell (MLC). Still other memory cells can be programmed to any one of eight data states (e.g., 000, 001, 010, 011, 100, 101, 110, 111), permitting the storage of three bits of data in a single cell. Such cells may be referred to as triple level cells (TLC). Even higher number of data states are possible, such as those found in quad level cells (QLC), which can be programmed to any one of 16 data states (e.g., 0000, 0001, 0010, 0011, 0100, 0101, 0110, 0111, 1000, 1001, 1010, 1011, 1100, 1101, 1110, 1111) for storing four bits of data. The memory cells 122 capable of storing higher numbers of data states can provide higher density memories without increasing the number of memory cells, since each cell can represent more than one bit.

The memory cells 122 can be arranged in rows (e.g., each corresponding to a word line) and columns (e.g., each corresponding to a bit line). Each word line can include one or more memory pages, depending upon the number of data states the memory cells 122 of that word line are configured to store. For example, a single word line of the memory cells 122 that are each configured to store one of two data states (e.g., SLC memory cells configured to store one bit each) can include a single memory page. Alternatively, a single word line of the memory cells 122 that are each configured to store one of four data states (e.g., MLC memory cells configured to store two bits each) can include two memory pages. Moreover, within the word line, pages can be interleaved so that the word line of memory cells 122 that are each configured to store one of two data states (e.g., SLC memory cells) can include two pages, in an “even-odd bit line architecture” (e.g., where all the memory cells 122 in odd-numbered columns of a single word line are grouped as a first page, and all the memory cells 122 in even-numbered columns of the same word line are grouped as a second page). When even-odd bit line architecture is utilized in the word line of memory cells 122 that are each configured to store larger numbers of data states (e.g., memory cells configured as MLC, TLC, QLC, etc.), the number of pages per word line can be even higher (e.g., 4, 6, 8, etc.). Each column can include a string of series-coupled memory cells 122 coupled to a common source. The memory cells 122 of each string can be connected in series between a source select transistor (e.g., a field-effect transistor) and a drain select transistor (e.g., a field-effect transistor). Source select transistors can be commonly coupled to a source select line, and drain select transistors can be commonly coupled to a drain select line.

The memory system 102 can process data using different groupings of the memory cells 122. For example, the memory pages of the memory cells 122 can be grouped into memory blocks. In operation, the data can be written or otherwise programmed (e.g., erased) with regards to the various memory regions of the memory system 102, such as by writing to groups of pages and/or memory blocks. In NAND-based memory, a write operation often includes programming the memory cells 122 in selected memory pages with specific data values (e.g., a string of data bits having a value of either logic 0 or logic 1). An erase operation is similar to a write operation, except that the erase operation re-programs an entire memory block or multiple memory blocks to the same data state (e.g., logic 0).

In other embodiments, the memory cells 122 can be arranged in different types of groups and/or hierarchies than shown in the illustrated embodiments. Further, while shown in the illustrated embodiments with a certain number of memory cells, rows, columns, blocks, and memory units for purposes of illustration, in other embodiments, the number of memory cells, rows, columns, blocks, and memory units can vary, and can be larger or smaller in scale than shown in the illustrated examples. For example, in some embodiments, the memory device 102 can include only one memory unit 120. Alternatively, the memory system 102 can include two, three, four, eight, ten, or more (e.g., 16, 32, 64, or more) memory units 120. While the memory units 120 are shown in FIG. 1 as including two memory blocks each, in other embodiments, each memory unit 120 can include one, three, four eight, or more (e.g., 16, 32, 64, 100, 128, 256 or more memory blocks). In some embodiments, each memory block can include, e.g., 215 memory pages, and each memory page within a block can include, e.g., 212 memory cells 122 (e.g., a “4k” page).

The controller 106 can be a microcontroller, special purpose logic circuitry (e.g., a field programmable gate array (FPGA), an application specific integrated circuit (ASIC), etc.), or other suitable processor. The controller 106 can include a processor 110 configured to execute instructions stored in memory. In the illustrated example, the memory of the controller 106 includes an embedded memory 112 configured to perform various processes, logic flows, and routines for controlling operation of the computing environment 100, including managing the memory system 102 and handling communications between the memory system 102 and the host device 108. In some embodiments, the embedded memory 112 can include memory registers storing, e.g., memory pointers, fetched data, etc. The embedded memory 112 can also include read-only memory (ROM) for storing micro-code. While the exemplary memory system 102 illustrated in FIG. 1 has been illustrated as including the controller 106, in another embodiment of the present technology, a memory device may not include a controller, and may instead rely upon external control (e.g., provided by an external host, or by a processor or controller separate from the memory system).

The memory system 102 can use processing levels for storing or accessing data. The processing levels can include thresholds or operating levels for voltage or current. For example, the processing levels can include a threshold voltage, a read level voltage, a programming level voltage, a programming step, or a combination thereof. The threshold voltage can be the voltage applied to the control gate at which the circuitry for the memory cells 122 becomes conductive and a current can be measured. The threshold voltage can be affected and controlled by controlling an amount of charge held in a floating gate or charge trap of the memory cells 122. The memory system 102 can store an amount of charge into the memory cells 122 based on the programming level voltage to represent a corresponding data value. The memory system 102 applies the programming level voltage to control gate or word line to charge up the floating gate or the charge trap. The floating gate or the charge trap can be electrically isolated, which can enable the memory cell to store and hold the charge.

The memory system 102 can use the stored charge to represent data. For example, storing charges on the floating gate or the charge trap can be for storing a bit value of 0 for SLC type cells. A bit value of 1 can correspond to the floating gate or the charge trap with no stored charge for the SLC. In other types of cells, such as for MLC, TLC, or QLC, the memory system 102 can store specific amounts of charge on the floating gate or the charge trap to represent different bit values. The MLC type of cell can have four different charge states, TLC can have eight different charge states, and QLC can have 16 different charge states. Each of the charge states can correspond to a unique binary value as discussed above.

The memory system 102 can read or determine data values stored in the memory cells 122 using the read level voltage corresponding to the data value. The memory system 102 can apply the read level voltage to the control gate and measure the current or the voltage across the memory cell to read the data stored in the cell. The charges stored in the floating gate or the charge trap can screen off or offset the amount of charge placed on control gate for reading or accessing the stored data. As such, with the read level voltage applied, the measured the current or the voltage across the memory cell will correspond to the amount of charges stored in the floating gate or the charge trap.

During operation of the memory system 102, the electrical characteristics of the device (i.e. charge retention capabilities) can change due to repeated data writes, erase, and/or reads. The repeated data operations can lead to the breakdown or wearing of the dielectric structure electrically isolating the floating gate or the charge trap (e.g. the oxide layers). To account for the changing electrical characteristics of the memory cells 122, the memory system 102 can be configured to shift or calibrate the read level voltage.

The programming level voltage is associated with the read level voltage and the threshold voltage. The programming level voltage, the read level voltage, the threshold voltage or a combination thereof can correspond to the number of bits stored in the memory cells 122.

For example, memory cells 122 configured to store charge in one of two possible states (e.g., SLC memory cells) may have associated programming levels, read levels and threshold voltages that are different from those used with of memory cells 122 configured to store charge in one of four possible states (e.g., MLC memory cells) or memory cells 122 configured to store charge in one of eight possible states (e.g., TLC memory cells). For each type of memory cell (e.g., SLC, MLC, TLC, QLC, etc.), a specific value of the programming level voltage, the read level voltage, the threshold voltage, or a combination thereof can be associated with each of the possible data values. The memory device 102 can iteratively store charge in the memory cells 122 for the write or program operation, such as for incremental step pulse programming (ISPP). The programming step can include an increment or a voltage value for increasing the stored charge in each iteration.

The memory system 102 can track an error measure. The error measure can represent a degree, a frequency, an amount or magnitude, a size or number, a processing derivation of the errors, or a combination thereof describing the errors. For example, the error measure can include an error count, an error rate, or a combination thereof. The error count can represent an amount or magnitude, a degree, a size or number, or a combination thereof describing the errors. For example, the error count can be a bit error count (BEC). The error rate can represent a frequency or a probability of occurrence of the errors, a proportional amount or a percentage of errors, or a combination thereof. For example, the error rate can include a bit error rate (BER). The error measure can correspond to one or more units or groupings within the memory devices 104. For example, the error measure can be for one or more of the memory pages, the memory cells 122, the word-line group, a die, or a combination thereof. Also for example, the error measure can correspond to the page type. The error measure can be calculated or tracked by the host device 108, the controller 106, or a combination thereof. The error measure can be stored in the host device 108, the embedded memory of the controller 106, the memory devices 104, another memory location of the memory system 102, or a combination thereof.

The memory system 102 can include a sampling adjustment mechanism 130 (e.g., circuitry, dedicated logic, programmable logic, firmware, etc.) to perform the operations described herein. In some embodiments, the controller 106 includes a sampling adjustment mechanism 130. For example, the controller 106 can include a processor 130 (processing device) configured to execute instructions stored in local memory 132 for performing the operations described herein. In some embodiments, the sampling adjustment mechanism 130 is part of the host system 108, an application, or an operating system.

The sampling adjustment mechanism 130 can be configured to adjust a sampling rate 132 of a sampling process 134 based on one or more parameters representing/corresponding to real-time (e.g., where parameters are processed with minimal delay such that it is available virtually immediately) condition/status associated with operation of the memory system 102. In some embodiments, the controller 106 includes a sampling adjustment mechanism 130. In some embodiments, the sampling adjustment mechanism 130 is part of the host system 108, an application, or an operating system. In implementing the sampling adjustment mechanism 130, the memory system 102 (e.g., the controller 106, the memory array 104, etc.) can gather data/information through the sampling process 134 at the sampling rate 132 (e.g., a timing, a cadence, etc. for triggering/initiating a data gathering operation). Based on real-time conditions/status of the memory system 102, the sampling process 134 can sample according to a variable sampling rate instead of a predetermined and fixed sampling rate. For example, the memory system 102 can change/adjust the sampling rate 132 and generate an adjusted rate 136. The memory system 102 can use the adjusted sampling rate 136, instead of the previous sampling rate, for the sampling process 134.

In some embodiments, the memory system generates the adjusted sampling rate 136 based on one or more environmental parameters 142 (e.g., representations of physical conditions concerning the memory system 102), one or more operational parameters 152 (e.g., representations of processes/operations/functions performed by the memory system 102), etc. For example, the environmental parameters 142 can include a system temperature 144, an operation rate 146 (e.g., a representation of a workload or a rate for received read/write commands), etc.

Also, the operational parameters 152 can include a device status 154 (e.g., NAND defectiveness measure, such as a number of retired/decommissioned memory units), a result/state associated with one or more device operations 156, etc.

The device operations 156 can include a read operation, a temperature sampling process, a garbage collection (GC) process, a background scan, a data refresh process, a continuous read level calibration (cRLC) mechanism/process, a dynamic program targeting (DPT) mechanism/process, a dynamic programming step (DPS) mechanism/process, etc.

In some embodiments, the operational parameters 152 can include a trigger rate 158, a performance characteristic 160 (e.g., the error measure 126), etc. of the device operations 156. In some embodiments, the operational parameters 152 can include changes/deviations (e.g., a parameter change 162) in the tracked data, such as the various different data illustrated above. For example, the parameter change 162 can include a rate change that corresponds to changes in rates (e.g., the operation rate 146, a rate of use for the error recovery mechanism 128, BER, etc.), an activity change that corresponds to a start/stop of device operations, such as write/read/erase operations, other system management operations (e.g., the device operations 156), an iteration or a portion thereof, etc.

In some embodiments, the memory system 102 can generate the adjusted sampling rate 136 based on comparing the environmental parameters 142, the operational parameters 152, etc., to one or more update thresholds 170 (e.g., a threshold measure that corresponds to the sampled data, such as a threshold temperature, a threshold error measure, a threshold refresh rate, a threshold corresponding to a change thereof, etc.).

In some embodiments, the sampling process 134 can include one or more processes for gathering/sampling the environmental parameters 142, the operational parameters 152, etc. For example, the sampling process 134 can include the process for determining/calculating the device temperature 144, the operation rate 146, the device status 154, the device operations 156, the trigger rate 158 (e.g., an implementation rate for one or more device operations, such as the GC, the error recovery mechanism 128, etc.), the performance characteristic 160, the parameter change 162, etc. In some embodiments, the real-time input parameters (e.g., the environmental parameters 142, the operational parameters 152, etc.) for generating the adjusted rate 136 can be a feedback measure from the sampling process 134. For example, the memory system 102 can generate the adjusted sampling rate 136 for sampling the temperature when the temperature matches/exceeds the update threshold 170 (e.g., a threshold temperature for the memory system 102 or a component therein).

In some embodiments, the memory system 102 can generate the adjusted sampling rate 136 based on incrementing the previous sampling rate 132 by a predetermined amount. In some embodiments, the memory system 102 can generate the adjusted sampling rate 136 by calculating the adjusted rate 136 according a predetermined equation/process that uses one or more parameters that represent real-time conditions/status (e.g., the environmental parameters 142, the operational parameters 152, etc.) as input(s).

In some embodiments, the memory system 102 can implement the sampling adjustment mechanism 130 using software, firmware, hardware, or a combination thereof. For example, the memory system 102 can include the sampling adjustment mechanism 130 stored in the embedded memory 112. Also, the memory system 102 can include the controller 106 configured to implement the sampling adjustment mechanism 130. Also for example, the memory system 102 can include analog/passive circuitry, digital circuitry (e.g., an analog-to-digital converter), or a combination thereof, such as a sensor, configured to generate a voltage and/or an analog signal corresponding to the environmental parameters 142, the operational parameters 152, etc.

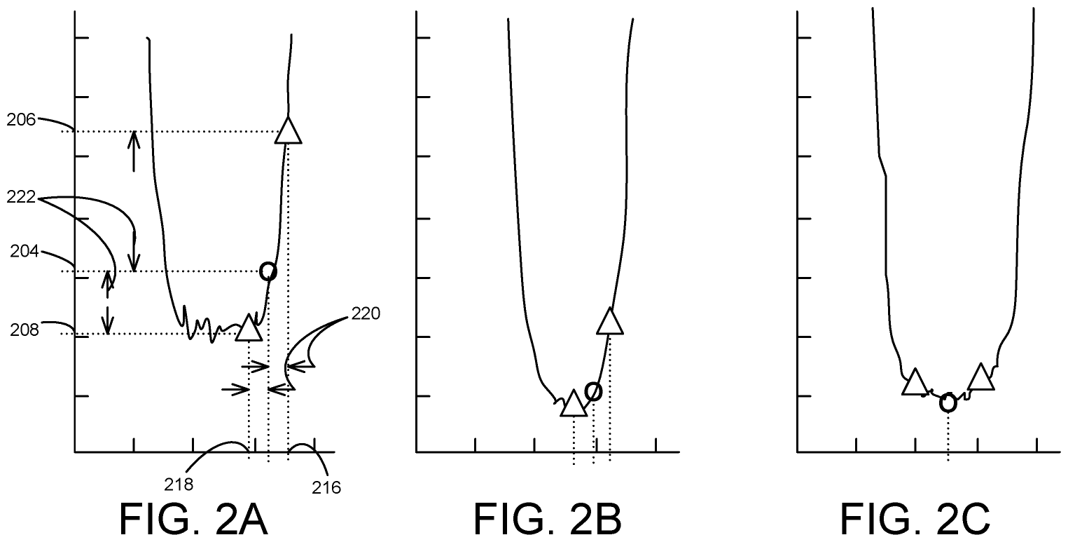

As an illustrative example, the memory system 102 can generate the adjusted rate 136 for the operational parameters 152 associated with the cRLC process. FIGS. 2A, 2B and 2C illustrate an example of a progression for a read level calibration (e.g., cRLC) in accordance with an embodiment of the present technology.

FIGS. 2A, 2B, and 2C show charts correlating the error measure (shown along the Y-axis) of a memory page with the read voltage (shown along the X-axis) used to read the data from the cells in accordance with an embodiment of the present technology. In this regard, FIGS. 2A, 2B and 2C show a progression for the cRLC adjusting the read level voltage to reduce the error measure. FIGS. 2A through 2C illustrate sequential changes, adjustments, or calibrations in the read level voltage and the corresponding samples/results as the cRLC is implemented. Based on the sampling adjustment mechanism 130 of FIG. 1, the sampling frequency (e.g., sampling of the error measure) can vary across the sequential changes illustrated in FIGS. 2A through 2C. The memory system 102 of FIG. 1 (e.g., the controller 106 and/or the memory devices 104, both of FIG. 1) can implement the cRLC (e.g., iterative changes, adjustments, or calibrations in the read level voltage) continuously during operation/deployment.

FIG. 2A illustrates an example diverged or unconverged state, such as prior to or in the absence of implementing the cRLC, in accordance with embodiments of the present disclosure. At such state, the read level trim (e.g., a current setting) can correspond to an error level that is higher than a lowest possible error level associated with the corresponding memory cells/page. Accordingly, the memory system 102 can implement the cRLC to adjust the read level value such that the corresponding error level will reduce and converge toward the lowest possible error level.

In implementing the cRLC, the memory system 102 can use one or more of the components therein to sample data (e.g., by performing a read using a corresponding read level voltage) and generate or update a test measurement set. The test measurement set can include a center result 204, a first offset result 206, a second offset result 208, other results, or a combination thereof. The memory system 102 can generate or update the test measurement set based on determining results corresponding to a set of read operations using the read level voltage or using a voltage offset from the read level voltage.

For example, the memory system 102 can determine the center result 204 based on determining the error measure 126 (e.g., an error count or rate) corresponding to reading or sampling a particular page type of an instance of the memory pages with the read level voltage. The center result 204 corresponding to original, unadjusted, or uncalibrated instance of the read level voltage is represented as “0” in FIG. 2A. The memory system 102 can similarly determine the first offset result 206 based on determining the error measure 126 corresponding to reading or sampling with a first offset level 216. The memory system 102 can similarly determine the second offset result 208 based on determining the error measure 126 corresponding to reading or sampling with a second offset level 218. The first offset level 216 is indicated by the vertical dotted line leading from the x-axis up to the plot. The corresponding location of the plot is shown as a triangle located to the right and above the center result 204 in FIG. 2A. The second offset level 218 is indicated by the vertical dotted line leading from the x-axis to the plot with the corresponding location on the plot located to the left and below the center result 204 in FIG. 2A. In some embodiments, the first offset level 216, the second offset level 218, or a combination thereof can be offset from the read level voltage by a predetermined offset measure 220, such as one or more clicks (e.g., a digital-to-analog converter granularity) or units of movement. The offset measure 220 can further represent a direction or a sign, a degree or a magnitude, or a combination thereof for the offset.

In implementing the cRLC, the memory system 102 can select a die, a memory block, a memory page, a trim or the read level voltage corresponding to one page type for the page, or a combination thereof. The selection can be made at random or according to an iterative process/pattern. Following the selection, the memory system 102 can sample at least the center result 204, the first offset result 206 and the second offset result 208 for the test measurement set. The memory system 102 can use the center result 204, the first offset result 206 and the second offset result 208 to adjust or calibrate the read level voltage.

The memory system 102 can calibrate the read level voltage, such as through adjusting or updating a previous value/level, based on comparing or balancing the various results. In some embodiments, the memory system 102 can additionally calibrate the read level voltage using the cRLC during or as part of manufacture, configuration, or set up of the memory system 102 FIG. 1, before intended deployment or usage thereof.

FIG. 2B illustrates an example read level voltage that has been adjusted or calibrated in comparison to that of FIG. 2A, in accordance with embodiments of the present disclosure. FIG. 2B can represent a moment (e.g., for one of the iterations) during implementation of the cRLC before the read level voltage has centered (e.g., settled or converged on an estimated lowest error measure) along the plot. For example, since a difference between the second offset result 208 and the center result 204 is less than a difference between the first offset result 206 and the center result 204, the read level voltage can be adjusted in a decreasing direction as illustrated between FIG. 2A and FIG. 2B. Also, when a difference between the second offset result 208 and the center result 204 is greater than a difference between the first offset result 206 and the center result 204, the read level voltage can be adjusted in an increasing direction. Accordingly, the cRLC can adjust the read level voltage to decrease the error measure for the corresponding memory cells 122, such as according to current condition or characteristics of the memory cells 122. In some embodiments, the read level voltage can be incremented or shifted by a predetermined amount or increment (e.g., clicks) based on comparing or balancing the various results. The process can repeat until the read level voltage and the corresponding results satisfy a stop or a break condition (e.g., a centered status/determination, a maximum iteration limit, etc.).

FIG. 2C illustrates an example centered or converged behavior/condition after implementation of the cRLC, in accordance with embodiments of the present disclosure. As the read level voltage is calibrated, it can move to be at or within a threshold distance from a bottom or minimum (e.g., center) of the error-read level correlation plot. Accordingly, the cRLC can find a read level voltage that reduces read errors based on iteratively testing different possible values of the read level voltage and comparing the corresponding error counts.

In some embodiments, the controller 106 can estimate that the read level is centered based on differences from the center result 204 and the surrounding read levels have opposing signs (e.g., positive and negative). Further, the controller 106 can estimate the center status based on further determining equal or similar (e.g., within a threshold) magnitudes in the differences between the center result 204 and the surrounding read levels. In some embodiments, the controller 106 can estimate that the read level is centered when a calibration pattern changes across iterations. For example, the controller 106 can store whether the read level settings were increased or decreased during one or more of the previous iterations. The controller 106 can determine a dither when the adjustment direction changes (e.g., from increase to decrease or vice versa). As illustrated in FIGS. 2A-2C, the controller 106 can determine the dithering status when the adjustments to the read level settings change from decrease/subtraction operations, such as from adjusting the read level settings to move left, to increase/addition operation.

As discussed above, the cRLC mechanism utilizes sampling operations associated with the read level voltage/read operation. The sampling operations for the cRLC mechanism (e.g., read operations) can be implemented according to the sampling rate 132 of FIG. 1. As discussed above, the memory system 102 can vary the sampling rate 132, such as by generating the adjusted sampling rate 136 of FIG. 1 and using it as a new sampling rate, according to various parameters (e.g., the environmental parameters 142 of FIG. 1, the operational parameters 152 of FIG. 1, etc.) that represent current/real-time conditions. As a result of varying the sampling rate 132, the memory system 102 can further influence a cadence or a rate of iteration for the cRLC mechanism.

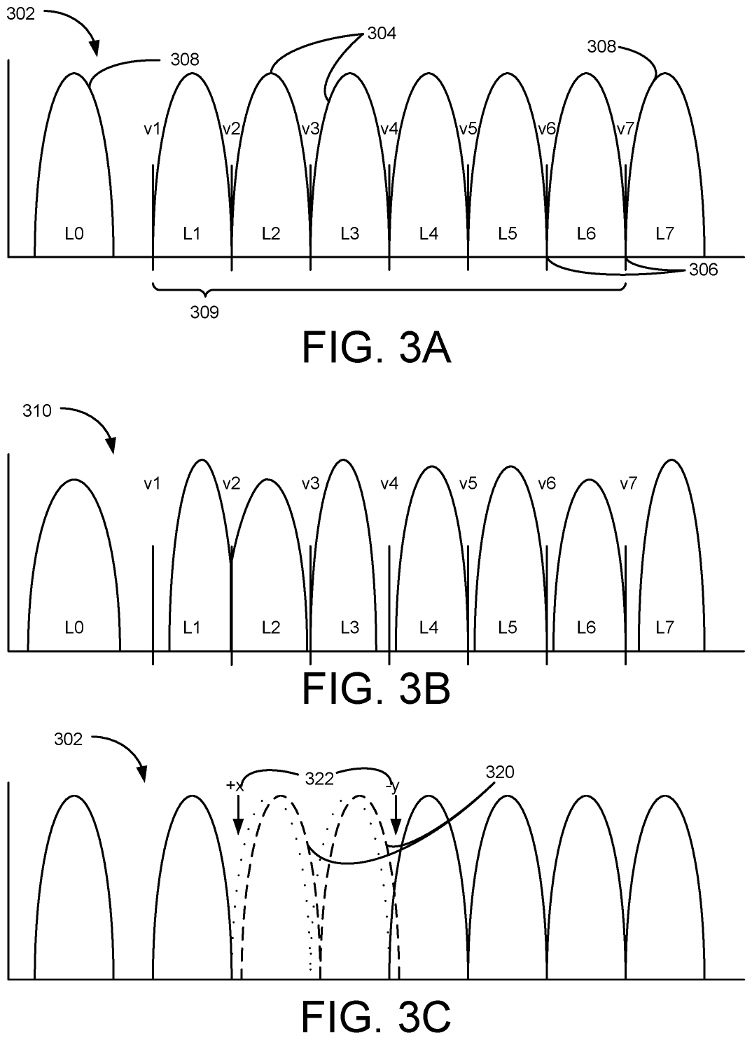

Also as an illustrative example, the memory device 102 can generate the adjusted rate 136 for the operational parameters 152 associated with the DPT mechanism. FIGS. 3A, 3B and 3C illustrate an example of a progression for a program targeting calibration in accordance with an embodiment of the present technology. Based on the sampling adjustment mechanism 130 of FIG. 1, the sampling frequency (e.g., sampling of the error measure, sampling of the read levels, etc.) can vary across the sequential changes illustrated in FIGS. 3A through 3C.

The DPT mechanism can adjust a desired distribution of program-verify levels according to the current behavior of the memory cells. FIGS. 3A, 3B and 3C correspond to a TLC page including or corresponding to a lower page (LP), an upper page (UP), and the extra page (XP). The example illustrations represent a number of occurrences for a specific trim level along a vertical direction or axis. The example illustrations show voltage levels along a horizontal direction or axis.

FIG. 3A illustrates an example of a target profile 302 for the memory system 102 of FIG. 1, in accordance with embodiments of the present disclosure. The target profile 302 is an objective or a desired result for a number of occurrences of the processing levels, such as the threshold voltage or the read level voltage for a given set of the memory cells 122 of FIG. 1, such as for a page, a logical or stored value, a word-line group, a word line, a die, or a combination thereof. For example, the target profile 302 can include program-verify (PV) target, a desired gray code distribution, a desired write distribution, or a combination thereof.

The memory system 102 can utilize the target profile 302 to control its behaviors, operations, or processes. The target profile 302 can specify a desired or targeted amount or quantity of the processing levels corresponding to the voltage levels, the page type, or a combination thereof. The memory system 102 can further adjust or calibrate the target profile 302 using the DPT mechanism. The target profile 302 can include a distribution target 304 for each logical value or corresponding voltage levels. The distribution target 304 can correspond to a set of desired quantities or occurrences of the processing levels corresponding to a specific content value, the page type, or a combination thereof. Each instance of the distribution target 304 can correspond to one unique instance of the possible content values. The voltage levels corresponding to the distribution target 304 can represent a satisfactory or desired range for the processing levels for the corresponding data value.

For TLC pages, such as exemplified in FIGS. 3A-3C, each of the memory cells 122 can store three bits. Storage of three bits can equate to eight possible content values of 0-7 or bit values of “000”, “001”, “010”, “011”, “100”, “101”, “110”, and “111”. Each of the possible content values is identified with level identification, such as L0-L1, in FIGS. 3A-3C. The assignment of the bit values to specific voltage ranges can be predetermined by the memory system 102, a developer or a manufacturer, a standard or a template, or a combination thereof. The target profile 302 can further include or represent a distribution valley 306. The distribution valley 306 is a representation of a relationship between adjacent distribution targets. The distribution valley 306 can represent an intersection, a separation, an overlap, or a combination thereof between two adjacent distribution targets. The distribution valleys 306 can each be between, at the boundary of, or a combination thereof between two adjacent instances of the distribution target 304. The distribution valley 306 can be where one or more of the distribution target 304 cross a threshold level or quantity, where multiple target levels meet or overlap, or a combination thereof.

For TLC pages, such as exemplified in FIGS. 3A-3C, there can be 8 valleys. Each of the distribution valleys 306 are identified with valley identification, such as v1-v7, in FIGS. 3A-3B (not shown in FIG. 3C). Each valley can correspond to a unique division or threshold for the LP, the UP, and the XP, which can be utilized to determine the content (e.g., the bit value) stored in the corresponding cells. Each of the distribution valleys 306 can be for determining the LP, the UP, the XP, the bit value at the corresponding location, or a combination thereof. The assignment or correlation between the distribution valleys 306 and the unique values and/or the page type can be based on a predetermined order, sequence, arrangement, or a combination thereof for the various bit value assignments.

In some embodiments, the memory system 102 can use edge targets 308 as reference points and dynamically adjust middle targets 309 for the DPT mechanism. The edge targets 308 represent instances of the distribution targets 304 corresponding to lowest and highest voltage levels. The middle targets 309 include instances of the distribution targets 304 between the edge targets 308. The memory system 102 can implement the DPT mechanism to adjust or balance the middle targets 309 or the corresponding distribution valleys 306.

FIG. 3B illustrates an example of a level distribution profile 310, in accordance with embodiments of the present disclosure. The level distribution profile 310 can be a histogram showing a number of memory cells 122 having a particular measured value (e.g., the threshold voltage). The level distribution profile 310 can represent an actual count or a current state of the memory cells 122. The target profile 302 can be for controlling or adjusting processes or levels to control or manage the level distribution profile 310. For example, the level distribution profile 310 can include actual program-verify states, actual gray code distribution, actual write distribution, or a combination thereof. The memory system 102 can determine and track various information for the level distribution profile 310. The level distribution profile 310 can change over time and usage. The level distribution profile 310 can further deviate from the target profile 302 due to the change, corresponding updates or changes to the processing levels, or a combination thereof. The memory system 102 can adjust or calibrate the target profile 302 accordingly with the DPT mechanism.

FIG. 3C illustrates an example adjustment, update, or calibration of the target profile 302, in accordance with embodiments of the present disclosure. The memory system 102 implementing the DPT mechanism can generate one or more adjusted targets 320 for replacing previous targets. In FIG. 3C, the previous targets, such as initially illustrated in FIG. 3A, are shown using dotted lines, and the adjusted targets 320 are shown using dashed lines. The memory system 102 can generate the adjusted targets 320 based on shifting or moving one or more previous targets higher or lower in voltage level, such as left or right as illustrated in FIGS. 3A-3C. The memory system 102 can generate the adjusted targets 320 based on target adjustment values 322. The target adjustment values 322 can represent a direction, an amount or magnitude, or a combination thereof for the change in the voltage level for the corresponding distribution target 304. The target adjustment values 322 can further correspond to changes in depth, magnitude, degree or amount, or a combination thereof for the corresponding distribution valley 306. The memory system 102 can implement the DPT mechanism and adjust the target profile 302 to balance the distribution targets 304, the distribution valleys 306, or a combination thereof across the various bit values.

The DPT mechanism can work in conjunction with the cRLC mechanism. For example, the DPT mechanism or a portion thereof can be triggered/initiated based on the cRLC mechanism or a status/result thereof. In some embodiments, the DPT mechanism can begin when the cRLC mechanism determines the centered status for a calibrated read level. In generating the adjusted targets 320, the memory system 102 can use data, such as the error measure 126, calculated during the cRLC mechanism based on the sampled reads. Thus, as a result of varying the sampling rate 132, the memory system 102 can further influence a cadence or a rate of implementation for the DPT mechanism.

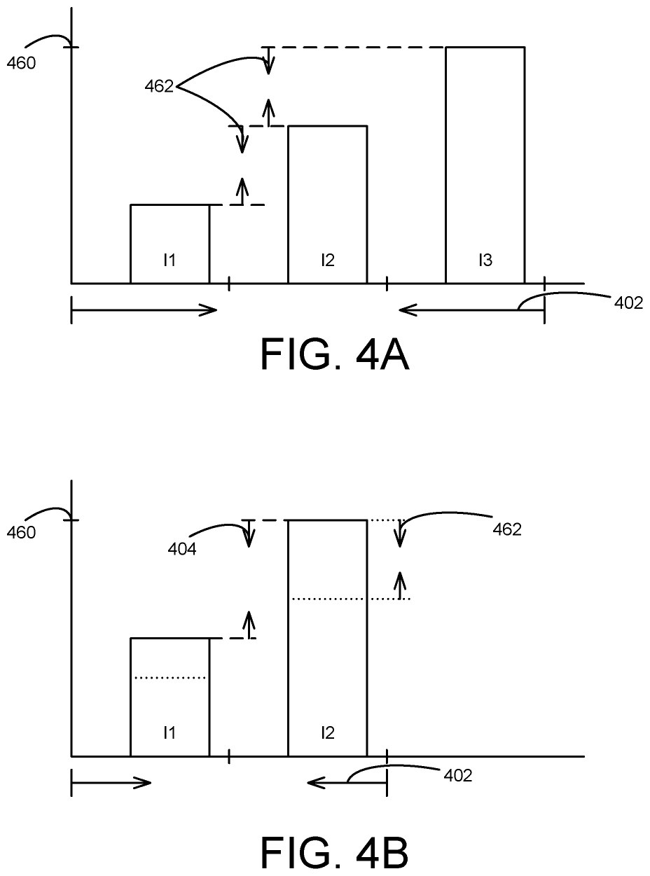

Further, as an illustrative example, the memory system 102 can generate the adjusted rate 136 for the operational parameters 152 associated with the DPS mechanism. FIGS. 4A and 4B illustrate an example of a progression for a program step calibration in accordance with an embodiment of the present technology. The example illustrations represent an amount of charge stored in the memory cell along a vertical direction or axis. The example illustrations show time along a horizontal direction or axis.

FIG. 4A illustrates a programming operation for a memory cell before implementing the DPS mechanism. The memory system 102 of FIG. 1 can program or write by storing a targeted amount of charge in the memory cell, where the targeted magnitude or level represents specific content or bit value. The memory system 102 can program or write by storing an amount of charge (e.g., a programming level voltage 406) corresponding to a desired data value. The memory system 102 can program or write by storing incremental amounts of charge into the memory cell in an iterative process, such as for ISPP. For example, the memory system 102 can iteratively apply multiple pulses for increasing the charge stored in the memory cell. The memory system 102 can use a programming step 462 to incrementally increase the stored charge until the stored magnitude or level matches the programming level voltage 460. The memory system 102 can program and verify for each pulse or iterations. The iterations are illustrated as I1′, I2′ and I3′ for FIG. 4A.

A programming time 402 is a duration associated with reaching the programming level voltage 460. The programming time 402 can be associated with a number of iterations needed to reach the programming level voltage 460, the programming step 462 utilized for each iteration, or a combination thereof. The memory system 102 can implement the DPS mechanism to dynamically adjust or calibrate the programming step 462. The memory system 102 can dynamically increase or decrease the programming step 462, which will correspondingly increase or decrease the programming time 402.

FIG. 4B illustrates the programming operation after implementing the DPS mechanism. For comparison, the previous levels and steps, such as in FIG. 4A, are illustrated with dotted lines. The DPS mechanism can generate an adjusted step 404. The adjusted step 404 is a calibrated or changed instance of the programming step 462 for replacing the programming step 462. The adjusted step 404 can be greater or lesser than the programming step 462.

Dynamically generating the adjusted step 404 to increase the programming step 462 provides the benefit of decreased programming time 402. The increase in the programming step 462 can reduce the number of pulses or iterations required to reach the programming level voltage 460, thereby reducing the corresponding amount of time. Thus, the dynamically calibration and adjustment of the programming step 462 improves overall efficiency for the memory system 102.

Moreover, the adjusted step 404 can be generated based on a feedback measure, or a processing result thereof, representing a trigger or an implementation for the error recovery mechanism 128 of FIG. 1. The consideration of triggering the error recovery mechanism 128 in generating the adjusted step 404 provides the reduction in the programming time 402 without increasing the error measure.

The DPS mechanism can use background records (e.g., results of background scans) to generate the adjusted step 404 (e.g., adjust the programming step 462). In some embodiments, the memory system 102 can determine the background records based on storing or tracking performance metrics or status associated with data processing during operation of the memory system 102. The memory system 102 can store or track the error measure 126 of FIG. 1 associated with or resulting from using the programming step during operation of the memory devices 104. The memory system 102 can implement the background scan to read one or more codewords in its search for “bad data.” The error measure, such as for a number of bit errors, can be determined during the background scan and tracked over a period of time.

In implementing the background scan, the memory system 102 can sample (e.g., read the codeword(s)) according to the sampling rate 132. In some embodiments, the memory system 102 can initiate the background scan according to the sampling rate 132. Thus, as a result of varying the sampling rate 132, the memory system 102 can further influence a cadence or a rate of implementation for the DPS mechanism.

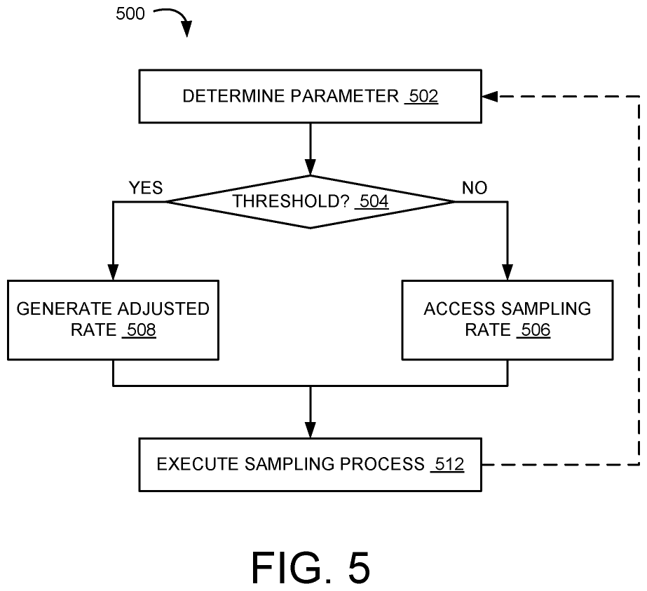

FIG. 5 is a flow diagram illustrating example method 500 for dynamically varying/adjusting one or more sampling rates, in accordance with some implementations of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the sampling adjustment mechanism 130 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various embodiments. Thus, not all processes are required in every implementation. Other process flows are possible.

At block 502, the processing device determines parameters that represent real-time condition/status of a memory system. For example, the processing device can continuously determine the environmental parameters 142 of FIG. 1, the operational parameters 152 of FIG. 1, etc. In some embodiments, the processing device can determine the environmental parameters 142 by determining a current physical state (e.g., the device temperature 144 of FIG. 1) of the memory system using one or more sensors (e.g., a temperature sensor) therein. In some embodiments, the processing device can determine the environmental parameters 142 by tracking or estimating the operation rate 146 of FIG. 1 according to commands received from the host 108, operations commanded by the controller 106, operations executed by the memory devices 104, etc.

In some embodiments, the processing device can determine the operational parameters 152 using the controller 106 and/or the memory devices 104 to track the device status 154 of FIG. 1 (e.g., a representation of an amount/degree defects in NAND). In some embodiments, the processing device can determine the operational parameters 152 by tracking a status (e.g., an iteration count or a progress measure) or a result of one or more device operations 156 of FIG. 1 (e.g., the read operation, the GC process, the background scan, the data refresh process, the cRLC mechanism, the DPT mechanism, the dynamic programming step DPS mechanism, etc.). In some embodiments, the processing device can determine the operational parameters 152 by tracking the trigger rate 158, the performance characteristic 160, etc. In some embodiments, the processing device can determine the operational parameters 152 by detecting the parameter change 162.

At decision block 504, the processing device compares the determined parameters to the update threshold 170 of FIG. 1. When the determined parameters do not satisfy the update threshold 170, such as not matching any specified conditions or having a value that does not reach a threshold or outside of a threshold range, the processing device can continue to use the previous/existing sampling rate (e.g., the sampling rate 132 of FIG. 1). For example, at block 506, the processing device can access/utilize the existing sampling rate 132.

When the determined parameters satisfy the update threshold 170, the processing device can generate the adjusted rate 136 of FIG. 1 for replacing the previous/existing sampling rate. For example, at block 508, the processing device can generate the adjusted rate 136.

In some embodiments, the processing device can generate the adjusted rate 136 based on incrementing the sampling rate 132 up or down along a predetermined direction and/or by a predetermined amount. In some embodiments, the processing device can generate the adjusted rate 136 by calculating the adjusted rate 136 according a predetermined equation/process that uses one or more parameters that represent real-time conditions/status (e.g., the environmental parameters 142, the operational parameters 152, etc.) as input(s). Accordingly, the processing device can generate the adjusted rate 136 similarly as using an analog function that can be applied in continuous or discrete samples instead of a monotonic fashion. As an illustrate example, the processing device can increase the sampling rate (e.g., read rate, iteration rate, etc.) of the cRLC mechanism, the DPT mechanism, etc. as the error measure 126 or the trigger rate 158 of the error recovery mechanism 128 increases and/or as the device status 154 worsens (e.g., increase in defective/worn NANDS). Also as an illustrated example, the processing device can increase the sampling rate of the DPS mechanism as the programming time, the estimated/determined workload, processing delay, etc. increases.

At block 512, the processing device executes the sampling process 134 of FIG. 1 to gather the corresponding data when the ongoing time delay satisfies the selected/adjusted sampling rate. The sample gathering time can be dynamically adjusted/varied based on the selected rate (e.g., the adjusted rate 136 or the existing sampling rate 132) as discussed above.

In some embodiments, the gathered sample can correspond to the determined parameter of block 502, such as for feedback measures. This can be illustrated using a dashed feedback line to block 502. For example, the sampling rate of the temperature sampling process can vary based on the current temperature. In some embodiments, the sampling rate can change when the current temperature reaches the threshold level or when it changes by a threshold amount. In some embodiments, the processing device can reset the threshold, the timing parameter, etc., when the adjusted rate 136 is used. Accordingly, the processing device can check the subsequent sample separately.

Based on the method 500, the processing device can continuously modulate the frequency of the sampling process over the life of the device. Further, the processing device can implement a need-based variation in the sampling frequency. Accordingly, using real-time measures (e.g., the environmental parameters 142, the operational parameters 152, etc.) to adjust the sampling rate of the sampling process 134 (e.g., the GC, the background scan, the data refresh, the cRLC, the DPT, the DPS, etc.) provide improved efficiency and granularity in tracking parameters. Accordingly, the sampling adjustment mechanism 130 can provide increased accuracy and/or decreased convergence time for the sampling process 134. Also with respect to the cRLC, the DPT, the DPS, etc., the sampling adjustment mechanism 130 can improve the overall system performance (e.g., lower error results, faster programming time, etc.) based on the increased accuracy and/or the decreased convergence time for the sampling processes.

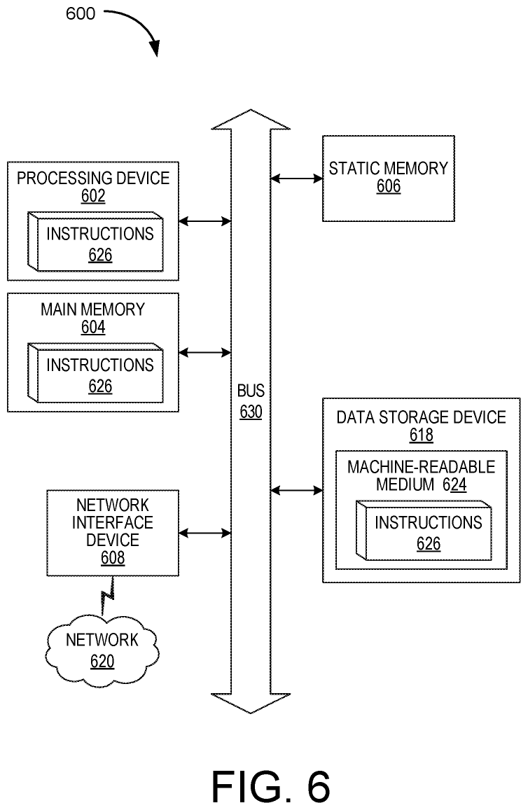

FIG. 6 illustrates an example machine of a computer system 600 within which a set of instructions, for causing the machine to perform any one or more of the methodologies discussed herein, can be executed. In some implementations, the computer system 600 can correspond to a host system (e.g., the host 108 of FIG. 1) that includes or utilizes a memory system (e.g., the memory system 102 of FIG. 1) or can be used to perform the operations of a controller (e.g., to execute an operating system to perform operations corresponding to the sampling adjustment mechanism 130 of FIG. 1). In alternative implementations, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random-access memory (DRAM) such as synchronous DRAM (SDRAM) or Rambus DRAM (RDRAM), etc.), a static memory 606 (e.g., flash memory, static random-access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions or software 626 embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory system 102 of FIG. 1.

In one implementation, the instructions 626 include instructions to implement functionality corresponding to a sampling adjustment mechanism (e.g., the sampling adjustment mechanism 130 of FIG. 1). While the machine-readable storage medium 624 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

I/We claim:

1. A system, comprising:
a memory device comprising a plurality of memory cells; and
a processing device coupled to the memory device, the processing device configured to:
determine at least one real-time measure including at least one environmental parameter or at least one operational parameter, or a combination thereof, wherein:
the environmental parameter corresponds to one or more physical conditions concerning the system,
the operational parameter represents one or more operations performed by the system; and
generate an adjusted sampling rate based on the real-time measure, wherein the adjusted sampling rate replaces a previous sampling rate used to control a timing associated with gathering information for a sampling process.

2. The system of claim 1, wherein the real-time measure is a feedback measure determined during implementation of the sampling process at the sampling rate.

3. The system of claim 1, wherein the sampling process comprises at least one of a continuous read level calibration (cRLC) mechanism, a dynamic program targeting (DPT) mechanism, a dynamic programming step (DPS) mechanism, a background scan, a read operation, or a temperature sampling process, or a combination thereof.

4. The system of claim 3, wherein the adjusted sampling rate controls timing of the read operation, or calculation of an error measure based on one or more read results, or a combination thereof.

5. The system of claim 3, wherein the adjusted sampling rate controls timing of implementing the cRLC mechanism, the DPT mechanism, the DPS mechanism, the background scan, a data refresh operation, or an iteration thereof, or a combination thereof.

6. The system of claim 3, wherein the cRLC mechanism iteratively adjusts a read level voltage based on a set of read results sampled according to the adjusted rate.

7. The system of claim 3, wherein the DPT mechanism iteratively adjusts a desired distribution of program-verify levels based on a set of read results sampled according to the adjusted rate.

8. The system of claim 3, wherein the DPS mechanism iteratively adjusts a programming step that is used in iteratively storing charges in one or more of the memory cells for a programming operation.

9. The system of claim 3, wherein the background scan reads code words stored in the memory cells and for determining error measures associated with the code words.

10. The system of claim 1, wherein the environmental parameter comprises a device temperature, or an operation rate, or a combination thereof, wherein the operation rate represents a frequency or a timing for an operation associated with the operational parameter.

11. The system of claim 1, wherein the operational parameter comprises a device status, a status or a result from a device operation, a trigger rate, a performance characteristic, or a parameter change, or a combination thereof.

12. The system of claim 11, wherein the device operation comprises a continuous read level calibration (cRLC) mechanism, a dynamic program targeting (DPT) mechanism, a dynamic programming step (DPS) mechanism, a background scan, a garbage collection process, or a data refresh process, or a combination thereof.

13. The system of claim 11, wherein the device status represents a level of defects in the memory cells.

14. The system of claim 1, wherein the plurality of memory cells is non-volatile.

15. The system of claim 1, wherein the processing device is further configured to:
compare the real-time measure to an update threshold; and
replace the sampling rate with the adjusted rate based on the comparison.

16. A method comprising:
determining at least one real-time measure including at least one environmental parameter or at least one operational parameter, or a combination thereof, wherein:
the environmental parameter corresponds to one or more physical conditions concerning a system,
the operational parameter represents one or more operations performed by the system; and
generating an adjusted sampling rate based on the real-time measure, wherein the adjusted sampling rate replaces a previous sampling rate used to control a timing associated with gathering information for a sampling process.

17. The method of claim 16, wherein the real-time measure is a feedback measure determined during implementation of the sampling process at the sampling rate.

18. The method of claim 16, wherein the sampling process comprises at least one of a continuous read level calibration (cRLC) mechanism, a dynamic program targeting (DPT) mechanism, a dynamic programming step (DPS) mechanism, a background scan, a read operation, or a temperature sampling process, or a combination thereof.

19. The method of claim 18, further comprising implementing the cRLC mechanism, the DPT mechanism, the DPS mechanism, the background scan, a data refresh operation, an iteration thereof, or a combination thereof according to the adjusted rate.

20. The method of claim 16, wherein the environmental parameter comprises a device temperature, an operation rate, or a combination thereof, wherein the operation rate represents a frequency or a timing for an operation associated with the operational parameter.
